(19) United States
(12) Patent Application Publication
(10) Pub. No.: US 2024/0406062 A1
(43) Pub. Date: Dec. 5, 2024

(54) METHOD AND APPARATUS FOR INITIALIZING SMART NETWORK INTERFACE CARD BY SERVER, DEVICE, AND MEDIUM

(71) Applicant: SUZHOU METABRAIN INTELLIGENT TECHNOLOGY CO., LTD., Suzhou, Jiangsu (CN)

(72) Inventors: Shanbin AI, Suzhou, Jiangsu (CN); Li Ming YAN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/696,255

(22) PCT Filed: Dec. 26, 2022
(86) PCT No.: PCT/CN2022/142092

§ 371 Date: Mar. 27, 2024

(30) Foreign Application Priority Data
Feb. 7, 2022 (CN) 202210115387.X

(51) Int. Cl. H04L 41/0806; G06F 13/20

(52) U.S. Cl. CPC H04L 41/0806; G06F 13/20; G06F 2213/40

(57) ABSTRACT

Provided are a method and apparatus for initializing a smart network interface card by a server, a device, and a readable medium. The method includes: establishing communication between a baseboard management controller (BMC) of the server and a BMC of the smart network interface card; configuring an integrated I/O module (IIO) of a central processing unit (CPU) by a server host, and initializing the smart network interface card in response to starting up the server; determining in response to configuration of the IIO of CPU by the server host is completed, by the BMC of the server through the communication with the BMC of the smart network interface card, whether the smart network interface card is completely initialized; connecting the IIO of CPU to the smart network interface card by the server host, and continuing executing startup process in response to initialization of the smart network interface card is completed.

### CROSS-REFERENCE TO RELATED APPLICATIONS

The present application is a National Stage Application of PCT International Application No.: PCT/CN2022/142092 filed on Dec. 26, 2022, which claims priority to Chinese Patent Application 202210115387.X, filed in the China National Intellectual Property Administration on Feb. 7, 2022, the disclosure of which is incorporated herein by reference in its entirety.

### TECHNICAL FIELD

The disclosure relates to the field of computers, and more particularly relates to a method and apparatus for initializing a smart network interface card by a server, a device, and a readable medium.

### BACKGROUND

Startup time of the smart network interface card keeps increasing due to its increasingly enhanced functions. By means of a peripheral component interconnect express (PCIE), the smart network interface card is connected to a server PCIE ROOT Port. After the server is started up, a server BIOS and a network interface card BIOS perform initialization simultaneously. Since the server initializes the PCIE earlier, as the time for the smart network interface card to fully initialize increases, the network interface card often does not get ready when the server initializes a PCIE physical link or driver with the smart network interface card. Thus, the network interface card may not be detected or the driver fails to load.

### SUMMARY

Some embodiments of the disclosure provide a method for initializing a smart network interface card by a server. The method includes steps as follows:
establishing communication between a BMC of the server and a BMC of the smart network interface card;
configuring an integrated I/O module (IIO) of a central processing unit (CPU) by a server host, and initializing the smart network interface card in response to starting up the server;
determining in response to configuration of the IIO of the CPU by the server host is completed, by the BMC of the server through the communication with the BMC of the smart network interface card, whether the smart network interface card is completely initialized; and
connecting the IIO of the CPU to the smart network interface card by the server host, and continuing executing a startup process in response to initialization of the smart network interface card is completed.

According to some embodiments of the disclosure, the initializing the smart network interface card includes:
starting a basic input output system (BIOS) of the smart network interface card;
configuring parameters of the smart network interface card; and
setting an initialization completion flag bit in the BMC of the smart network interface card in response to configuration of the smart network interface card is completed.

According to some embodiments of the disclosure, the determining, by the BMC of the server through the communication with the BMC of the smart network interface card, whether the smart network interface card is completely initialized includes:
acquiring the initialization completion flag bit in the BMC of the smart network interface card by the BMC of the server through the communication with the BMC of the smart network interface card; and
determining that the smart network interface card is completely initialized in response to a case that the BMC of the server acquires the initialization completion flag bit.

According to some embodiments of the disclosure, the method further includes:
re-determining in response to initialization of the smart network interface card is not completed, by the server every preset time, whether the smart network interface card is completely initialized.

Some embodiments of the disclosure further provide an apparatus for initializing a smart network interface card by a server. The apparatus includes:
an establishment component, which is configured to establish communication between a BMC of the server and a BMC of the smart network interface card;
an initialization component, which is configured to configure an IIO of a CPU by a server host and initialize the smart network interface card in response to starting up the server;
a determination component, which is configured to determine in response to configuration of the IIO of the CPU by the server host is completed, by the BMC of the server through the communication with the BMC of the smart network interface card, whether the smart network interface card is completely initialized; and
a connection component, which is configured to connect the IIO of the CPU to the smart network interface card by the server host and continue executing a startup process in response to initialization of the smart network interface card is completed.

According to some embodiments of the disclosure, the initialization component is further configured to:
start a BIOS of the smart network interface card;
configure parameters of the smart network interface card; and
set an initialization completion flag bit in the BMC of the smart network interface card in response to configuration of the smart network interface card is completed.

According to some embodiments of the disclosure, the determination component is further configured to:
acquire the initialization completion flag bit in the BMC of the smart network interface card by the BMC of the server through the communication with the BMC of the smart network interface card; and
determine that the smart network interface card is completely initialized in response to a case that the BMC of the server acquires the initialization completion flag bit.

According to some embodiments of the disclosure, the apparatus further includes a retry component. The retry component is configured to:
re-determine in response to initialization of the smart network interface card is not completed, by the server every preset time, whether the smart network interface card is completely initialized.

Some embodiments of the disclosure further provide a computer device. The computer device includes:
at least one processor; and
a memory, which stores a computer instruction capable of running on the processor. The computer instruction implements steps of any one of the above methods when executed by the processor.

Some embodiments of the disclosure further provide a non-transitory computer-readable storage medium. The non-transitory computer-readable storage medium stores a computer program. The computer program implements steps of any one of the above methods when executed by a processor.

### BRIEF DESCRIPTION OF THE DRAWINGS

In order to describe the technical solutions in some embodiments of the disclosure or in the related art more clearly, the accompanying drawings required to be used in the descriptions of the accompanying or the related art will be briefly introduced below. Apparently, the accompanying drawings in the following descriptions only are some embodiments of the disclosure. Those of ordinary skill in the art may also derive other embodiments according to these accompanying drawings without making creative efforts.

FIG. 1 is a schematic flow diagram of a method for initializing a smart network interface card by a server according to some embodiments of the disclosure;

FIG. 2 is a schematic diagram of an apparatus for initializing a smart network interface card by a server according to some embodiments of the disclosure;

FIG. 3 is a schematic diagram of a computer device according to some embodiments of the disclosure; and

FIG. 4 is a schematic diagram of a non-transitory computer-readable storage medium according to some embodiments of the disclosure.

### DETAILED DESCRIPTION OF THE EMBODIMENTS

In order to make the objective, technical solutions and advantages of the disclosure clearer, some embodiments of the disclosure will be further described in detail below in combination with particular embodiments and with reference to accompanying drawings.

As server technologies burgeon, performances and functions of servers are continuously enhanced. A basic input output system (BIOS), which is a manager for the lowest and most direct hardware setting and control of a server motherboard, may provide more simple and easy functions for the server. The BIOS is a set of programs solidified on a read-only memory (ROM) chip on the motherboard. It stores paramount basic input and output programs, system setting information, self-check programs after startup, and system self-startup programs of a computer. Its main function is to provide the lowest and most direct hardware setting and control for the computer.

As a product which emerges in recent years and has more powerful and smart functions than a general network interface card, a smart network interface card is a small server system assisting a central processing unit (CPU) in dealing with tricky network-related transactions.

After the server is started up, a server BIOS and a network interface card BIOS perform initialization simultaneously. Since the server initializes the PCIE earlier, as the time for the smart network interface card to fully initialize increases, the network interface card often does not get ready when the server initializes a PCIE physical link or driver with the smart network interface card. Thus, the network interface card may not be detected or the driver fails to load. In addition, the server will generally close the Port to save electricity when it is detected that the PCIE has no physical link, so as to save energy. As a result, the network interface card may not establish a connection subsequently even if it is initialized. In order to solve the above problems, a common method is to keep a server PCIE Port always opened, and delay PCIE initialization for a fixed time for wait. However, through this method, the startup time is increased no matter whether the server is connected to the smart network interface card. Moreover, due to upgrade and change of smart network interface card firmware (FW)/operating system (0S), wait time may not be accurately estimated.

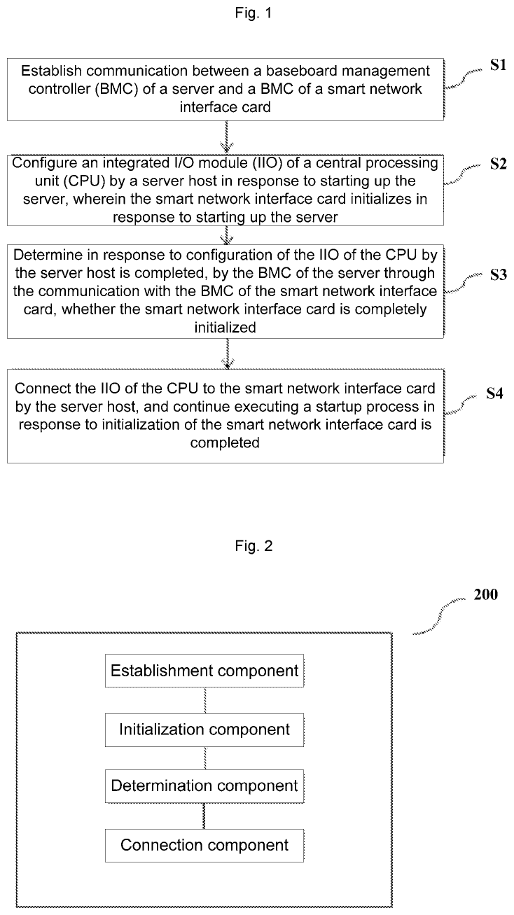

On the basis of the above objective, some embodiments of the disclosure provide a method for initializing a smart network interface card by a server. FIG. 1 shows a schematic flow diagram of the method.

As shown in FIG. 1, the method may include steps as follows:

S1: Establish communication between a baseboard management controller (BMC) of a server and a BMC of a smart network interface card.

In general, the BMC of the server is not connected to the BMC of the smart network interface card. In the technical solution of the disclosure, it is required to connect the BMC of the server to the BMC of the smart network interface card by means of an inter-integrated circuit (I2C) or a network cable. Communication between the BMC of the server and the BMC of the smart network interface card is established. That is, the BMC of the server may access the BMC of the smart network interface card and acquire related information.

S2: Configure an integrated I/O module (IIO) of a central processing unit (CPU) by a server host, and initialize the smart network interface card in response to starting up the server.

When the server is started, the server and the smart network interface card are powered on simultaneously. The smart network interface card performs an initialization process while the server host configures the IIO of the CPU. The initialization process of the smart network interface card includes start a basic input output system (BIOS) of the smart network interface card, configure parameters of the smart network interface card after starting the BIOS of the smart network interface card is finished, set an initialization completion flag bit in the BMC of the smart network interface card after the smart network interface card is completely configured, and indicate that the smart network interface card is completely initialized.

S3: Determine in response to configuration of the IIO of the CPU by the server host is completed, by the BMC of the server through the communication with the BMC of the smart network interface card, whether the smart network interface card is completely initialized.

When the server host configures the IIO of the CPU, the BMC of the smart network interface card is accessed by the BMC of the server, and whether the smart network interface card is completely initialized is determined. In some embodiments of the disclosure, the BMC of the server acquires the initialization completion flag bit from the BMC of the smart network interface card. If the initialization completion flag bit is acquired, it is indicated that the smart network interface card is completely initialized. If the initialization completion flag bit is not acquired, it is indicated that the smart network interface card is not completely initialized.

S4: Connect the IIO of the CPU to the smart network interface card by the server host, and continue executing a startup process in response to initialization of the smart network interface card is completed.

If the smart network interface card is completely initialized, the server host connects the IIO of the CPU to the smart network interface card, and then executes other normal startup processes until the server is completely started up.

By using the technical solution of the disclosure, under the condition that information of the smart network interface card may not be known by means of a peripheral component interconnect express (PCIE) link, a state of a network interface card may be inspected by means of the BMC, and startup time of the server may be reduced.

In some embodiments of the disclosure, the step of initializing the smart network interface card includes:
start a BIOS of the smart network interface card;
configure parameters of the smart network interface card; and
set an initialization completion flag bit in the BMC of the smart network interface card in response to configuration of the smart network interface card is completed. The initialization completion flag bit is stored in the BMC of the smart network interface card. When the server is started up to an assigned stage, the BMC of the server accesses the BMC of the smart network interface card, such that the initialization completion flag bit is acquired from the BMC of the smart network interface card. Moreover, whether the smart network interface card is completely initialized is determined according to whether the initialization completion flag bit may be acquired.

In some embodiments of the disclosure, the step of determining, by the BMC of the server through the communication with the BMC of the smart network interface card, whether the smart network interface card is completely initialized includes:
acquire the initialization completion flag bit in the BMC of the smart network interface card by the BMC of the server through the communication with the BMC of the smart network interface card; and
determine that the smart network interface card is completely initialized in response to a case that the BMC of the server acquires the initialization completion flag bit.

In some embodiments of the disclosure, the method further includes:
re-determine in response to initialization of the smart network interface card is not completed, by the server every preset time, whether the smart network interface card is completely initialized. If the smart network interface card is not completely initialized, the server is required to be stopped from executing other startup processes. The server re-determines whether the smart network interface card is completely initialized every certain time. The determination method is the same as above. After the smart network interface card is completely initialized, the server continues to execute the following startup process.

By using the technical solution of the disclosure, under the condition that information of the smart network interface card may not be known by means of a PCIE link, a state of a network interface card may be inspected by means of the BMC, and startup time of the server may be reduced.

It should be noted that those of ordinary skill in the art may understand that all or some processes of the method in the above embodiments may be implemented by related hardware instructed by a computer program. The above program may be stored in a non-transitory computer-readable storage medium. The program may include processes of the embodiments of the above method when executed. The storage medium may be a magnetic disc, an optical disc, a read-only memory (ROM) or a random access memory (RAM), etc. The embodiment of the above computer program may achieve the same or similar effects as any of the foregoing method embodiments corresponding thereto.

In addition, the method disclosed according to some embodiments of the disclosure may also be implemented as a computer program execute by a CPU. The computer program may be stored in a non-transitory computer-readable storage medium. The computer program executes the above functions defined in the method disclosed in some embodiments of the disclosure when executed by the CPU.

On the basis of the above objective, some embodiments of the disclosure provide an apparatus for initializing a smart network interface card by a server. As shown in FIG. 2, the apparatus 200 includes:
an establishment component, which is configured to establish communication between a BMC of the server and a BMC of the smart network interface card;
an initialization component, which is configured to configure an IIO of a CPU by a server host and initialize the smart network interface card in response to starting up the server;
a determination component, which is configured to determine in response to configuration of the IIO of the CPU by the server host is completed, by the BMC of the server through the communication with the BMC of the smart network interface card, whether the smart network interface card is completely initialized; and
a connection component, which is configured to connect the IIO of the CPU to the smart network interface card by the server host and continue executing a startup process in response to initialization of the smart network interface card is completed.

In some embodiments of the disclosure, the initialization component is further configured to:
start a BIOS of the smart network interface card;
configure parameters of the smart network interface card; and
set an initialization completion flag bit in the BMC of the smart network interface card in response to configuration of the smart network interface card is completed.

In some embodiments of the disclosure, the determination component is further configured to:
acquire the initialization completion flag bit in the BMC of the smart network interface card by the BMC of the server through the communication with the BMC of the smart network interface card; and
determine that the smart network interface card is completely initialized in response to a case that the BMC of the server acquires the initialization completion flag bit.

In some embodiments of the disclosure, the apparatus further includes a retry component. The retry component is configured to:
re-determine in response to initialization of the smart network interface card is not completed, by the server every preset time, whether the smart network interface card is completely initialized.

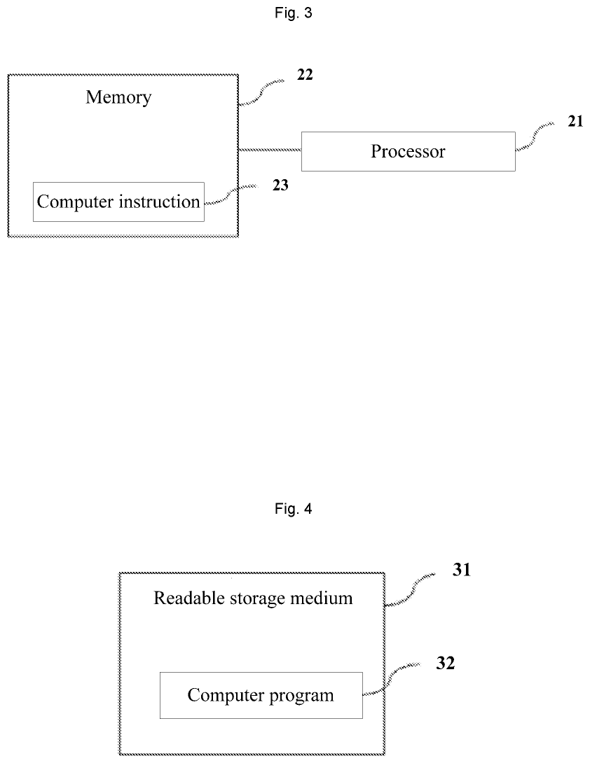

On the basis of the above objective, some embodiments of the disclosure provide a computer device. FIG. 3 shows a schematic diagram of an embodiment of a computer device provided in the disclosure. As shown in FIG. 3, some embodiments of the disclosure include apparatuses as follows: at least one processor 21; and a memory 22. The memory 22 stores a computer instruction 23 capable of running on the processor. When executed by the processor, the computer instruction implements a method as follows:
establish communication between a BMC of the server and a BMC of the smart network interface card;
configure an IIO of a CPU by a server host, and initialize the smart network interface card in response to starting up the server;
determine in response to configuration of the IIO of the CPU by the server host is completed, by the BMC of the server through the communication with the BMC of the smart network interface card, whether the smart network interface card is completely initialized; and
connect the IIO of the CPU to the smart network interface card by the server host, and continue executing a startup process in response to initialization of the smart network interface card is completed.

In some embodiments of the disclosure, the step of initializing the smart network interface card includes:
start a BIOS of the smart network interface card;
configure parameters of the smart network interface card; and
set an initialization completion flag bit in the BMC of the smart network interface card in response to configuration of the smart network interface card is completed.

In some embodiments of the disclosure, the step of determining, by the BMC of the server through the communication with the BMC of the smart network interface card, whether the smart network interface card is completely initialized includes:
acquire the initialization completion flag bit in the BMC of the smart network interface card by the BMC of the server through the communication with the BMC of the smart network interface card; and
determine that the smart network interface card is completely initialized in response to a case that the BMC of the server acquires the initialization completion flag bit.

In some embodiments of the disclosure, the method further includes:
re-determine in response to initialization of the smart network interface card is not completed, by the server every preset time, whether the smart network interface card is completely initialized.

On the basis of the above objective, some embodiments of the disclosure provide a non-transitory computer-readable storage medium. FIG. 4 shows a schematic diagram of an embodiment of a non-transitory computer-readable storage medium provided in the disclosure. As shown in FIG. 4, the non-transitory computer-readable storage medium 31 stores a computer program 32. When executed by the processor, the computer program executes a method as follows:
establish communication between a BMC of the server and a BMC of the smart network interface card;
configure an IIO of a CPU by a server host, and initialize the smart network interface card in response to starting up the server;
determine in response to configuration of the IIO of the CPU by the server host is completed, by the BMC of the server through the communication with the BMC of the smart network interface card, whether the smart network interface card is completely initialized; and
connect the IIO of the CPU to the smart network interface card by the server host, and continue executing a startup process in response to initialization of the smart network interface card is completed.

In some embodiments of the disclosure, the step of initializing the smart network interface card includes:
start a BIOS of the smart network interface card;
configure parameters of the smart network interface card; and
set an initialization completion flag bit in the BMC of the smart network interface card in response to configuration of the smart network interface card is completed.

In some embodiments of the disclosure, the step of determining, by the BMC of the server through the communication with the BMC of the smart network interface card, whether the smart network interface card is completely initialized includes:
acquire the initialization completion flag bit in the BMC of the smart network interface card by the BMC of the server through the communication with the BMC of the smart network interface card; and
determine that the smart network interface card is completely initialized in response to a case that the BMC of the server acquires the initialization completion flag bit.

In some embodiments of the disclosure, the method further includes:
re-determine in response to initialization of the smart network interface card is not completed, by the server every preset time, whether the smart network interface card is completely initialized.

In addition, the method disclosed according to some embodiments of the disclosure may also be implemented as a computer program execute by a processor. The computer program may be stored in a non-transitory computer-readable storage medium. The computer program executes the above functions defined in the method disclosed in some embodiments of the disclosure when executed by the processor.

In addition, the above method steps and system units may also be implemented by using a controller and a non-transitory computer-readable storage medium configured to store a computer program causing the controller to implement functions of the above steps or units.

Those skilled in the art will further understand that various illustrative logical blocks, components, circuits and algorithm steps described in combination with the disclosure herein may be implemented as electronic hardware, computer software or their combination. In order to clearly illustrate such interchangeability between the hardware and software, functions of various illustrative assemblies, blocks, components, circuits and steps are described generally. Whether such functions are implemented as software or hardware depends on particular applications and design constraints imposed on the overall system. Those skilled in the art may implement functions in various ways for each particular application, but such implementation decisions should not be interpreted as causing a departure from the scope disclosed by some embodiments of the disclosure.

In one or more exemplary designs, functions may be implemented in hardware, software, firmware or their any combination. When implemented in the software, the functions may be stored on a computer-readable medium or transmitted by means of the computer-readable medium as one or more instructions or codes. The computer-readable medium includes a computer storage medium and a communication medium. The communication medium includes any medium that is conducive to transfer of a computer program from one position to another position. The storage medium may be any available medium that may be accessed by a general-purpose or special-purpose computer. In an exemplary and nonrestrictive way, the computer-readable medium may include an RAM, an ROM, an electrically erasable programmable read-only memory (EEPROM), a compact disc read-only memory (CD-ROM) or other optical disc storage devices, a magnetic disc storage device or other magnetic storage devices, or any other media that may be configured to carry or store required program code in the form of instructions or data structures and may be accessed by a general-purpose or special-purpose computer, or a general-purpose or special-purpose processor. In addition, any connection may be properly referred to as a computer-readable medium. For instance, if the software is transmitted from a website, a server or other remote sources by using a coaxial cable, a fiber optic cable, a twisted pair, a digital subscriber line (DSL) or infrared, radio, microwave and other wireless technologies, the above coaxial cable, fiber optic cable, twisted pair, DSL or infrared, radio, microwave and other wireless technologies are all included in definitions of medium. As used herein, the magnetic disc and optical disc include a compact disc (CD), a laser disc, an optical disc, a digital video disc (DVD), a floppy disc and a Blu-ray disc. The magnetic disc generally magnetically reproduces data. The optical disc optically reproduces data by using laser light. Combinations of the above contents should also fall within the scope of the computer-readable medium.

The above examples are exemplary embodiments disclosed in the disclosure. However, it should be noted that various changes and modifications may be made without departing from the scope disclosed by some embodiments of the disclosure as defined in the claims. Functions, steps and/or actions of method claims according to the disclosed embodiments described herein are not required to be executed in any particular order. In addition, although elements disclosed in some embodiments of the disclosure may be described or claimed in an individual form, the elements may also be construed as in a plural form unless explicitly limited to be in a singular form.

It should be understood that as used herein, the singular forms “a” and “an” are also intended to include a plural form, unless the context clearly supports exceptions. It should also be understood that “and/or” as used herein is meant to include any and all possible combinations of one or more associatively listed items.

The above embodiment sequence numbers disclosed by some embodiments of the disclosure are merely used for description, and do not indicate advantages and disadvantages of the embodiments.

Those of ordinary skill in the art may understand that all or some steps for implementing the above embodiments may be implemented by hardware, or may be implemented by related hardware instructed by a program. The program may be stored in a non-transitory computer-readable storage medium. The above storage medium may be a read-only memory, a magnetic disc or an optical disc, etc.

Those of ordinary skill in the art should understand that the discussion of any above embodiment is merely illustrative, and is not intended to imply that the scope (including the claims) disclosed by the embodiments of the disclosure is limited to these instances. According to ideas of some embodiments of the disclosure, technical features in the above embodiments or different embodiments may also be combined with each other, and there are many other variations of different aspects of some embodiments of the disclosure as described above, which are not provided in detail for the sake of brevity. Therefore, any omission, modification, equivalent substitution, improvement, etc. made within the spirit and principles of the disclosure should fall within the scope of protection of some embodiments of the disclosure.

1. A method for initializing a smart network interface card by a server, comprising steps as follows:
establishing communication between a baseboard management controller (BMC) of the server and a BMC of the smart network interface card;
configuring an integrated I/O module (IIO) of a central processing unit (CPU) by a server host in response to starting up the server, wherein the smart network interface card initializes in response to starting up the server;
determining in response to configuration of the IIO of the CPU by the server host is completed, by the BMC of the server through the communication with the BMC of the smart network interface card, whether the smart network interface card is completely initialized; and
connecting the IIO of the CPU to the smart network interface card by the server host, and continuing executing a startup process in response to initialization of the smart network interface card is completed.

2. The method as claimed in claim 1, wherein the initializing the smart network interface card comprises:
starting a basic input output system (BIOS) of the smart network interface card;
configuring parameters of the smart network interface card; and
setting an initialization completion flag bit in the BMC of the smart network interface card in response to configuration of the smart network interface card is completed.

3. The method as claimed in claim 2, wherein the determining, by the BMC of the server through the communication with the BMC of the smart network interface card, whether the smart network interface card is completely initialized comprises:
inspecting a state of the smart network interface card by the BMC of the server through the communication with the BMC of the smart network interface card, and determining whether the smart network interface card is completely initialized.

4. The method as claimed in claim 3, wherein the inspecting the state of the smart network interface card by the BMC of the server through the communication with the BMC of the smart network interface card, and determining whether the smart network interface card is completely initialized comprise:
accessing the BMC of the smart network interface card by the BMC of the server, and acquiring initialization information, wherein the initialization information is information configured to determine whether the smart network interface card is completely initialized.

5. The method as claimed in claim 4, wherein the accessing the BMC of the smart network interface card by the BMC of the server comprises:
accessing the BMC of the smart network interface card by the BMC of the server in response to that the server is started up to an assigned stage.

6. The method as claimed in claim 2, wherein the determining, by the BMC of the server through the communication with the BMC of the smart network interface card, whether the smart network interface card is completely initialized comprises:
acquiring the initialization completion flag bit in the BMC of the smart network interface card by the BMC of the server through the communication with the BMC of the smart network interface card; and
determining whether the smart network interface card is completely initialized according to whether the initialization completion flag bit is acquired.

7. The method as claimed in claim 6, wherein the determining, by the BMC of the server through the communication with the BMC of the smart network interface card, whether the smart network interface card is completely initialized further comprises:
determining that the smart network interface card is completely initialized in a case that the BMC of the server acquires the initialization completion flag bit.

8. The method as claimed in claim 6, wherein the determining, by the BMC of the server through the communication with the BMC of the smart network interface card, whether the smart network interface card is completely initialized further comprises:
determining that the smart network interface card is not completely initialized in a case that the BMC of the server does not acquire the initialization completion flag bit.

9. The method as claimed in claim 1, further comprising:
re-determining in response to initialization of the smart network interface card is not completed, by the server every preset time, whether the smart network interface card is completely initialized.

10. The method as claimed in claim 9, wherein in response to initialization of the smart network interface card is not completed, the method further comprises: stopping the server from executing other startup processes.

11. The method as claimed in claim 10, wherein after the re-determining, by the server every preset time, whether the smart network interface card is completely initialized, the method further comprises:
continuing executing a startup process by the server in a case that after preset time, the server re-determines that the smart network interface card is completely initialized.

12. The method as claimed in claim 1, wherein before the establishing communication between the BMC of the server and the BMC of the smart network interface card, the method further comprises:
connecting the BMC of the server to the BMC of the smart network interface card by using a connection line.

13. The method as claimed in claim 12, wherein the connection line comprises one of an inter-integrated circuit (I2C) and a network cable, and the connecting the BMC of the server to the BMC of the smart network interface card by using the connection line comprises:
connecting the BMC of the server to the BMC of the smart network interface card by using the I2C or the network cable.

14. The method as claimed in claim 1, wherein the configuring the IIO of the CPU by the server host, and initializing the smart network interface card in response to starting up the server comprise:
powering on the server and the smart network interface card simultaneously, configuring the IIO of the CPU by the server host, and initializing the smart network interface card in response to starting up the server.

15. The method as claimed in claim 2, wherein after the setting the initialization completion flag bit in the BMC of the smart network interface card, the method further comprises:
storing the initialization completion flag bit in the BMC of the smart network interface card.

16. The method as claimed in claim 15, wherein the initialization completion flag bit is configured to indicate that the smart network interface card is completely initialized.

17. The method as claimed in claim 1, wherein the connecting the IIO of the CPU to the smart network interface card by the server host, and continuing executing the startup process comprise:
connecting the IIO of the CPU to the smart network interface card by the server host, and continuing executing the startup process until the server is completely started up.

18. (canceled)

19. A computer device, comprising:
at least one processor; and
a memory, which stores a computer instruction capable of running on the processor, wherein the computer instruction, when executed by the processor, cause the processor to:
establish communication between a baseboard management controller (BMC) of the server and a BMC of the smart network interface card;
configure an integrated I/O module (IIO) of a central processing unit (CPU) by a server host in response to starting up the server, wherein the smart network interface card initializes in response to starting up the server;
determine in response to configuration of the IIO of the CPU by the server host is completed, by the BMC of the server through the communication with the BMC of the smart network interface card, whether the smart network interface card is completely initialized; and
connect the IIO of the CPU to the smart network interface card by the server host, and continue executing a startup process in response to initialization of the smart network interface card is completed.

20. A non-transitory computer-readable storage medium, storing a computer program, wherein the computer program, when executed by a processor, cause the processor to:
establish communication between a baseboard management controller (BMC) of the server and a BMC of the smart network interface card;
configure an integrated I/O module (IIO) of a central processing unit (CPU) by a server host in response to starting up the server, wherein the smart network interface card initializes in response to starting up the server;
determine in response to configuration of the IIO of the CPU by the server host is completed, by the BMC of the server through the communication with the BMC of the smart network interface card, whether the smart network interface card is completely initialized; and
connect the IIO of the CPU to the smart network interface card by the server host, and continue executing a startup process in response to initialization of the smart network interface card is completed.

21. The computer device as claimed in claim 19, the processor is further configured to:
start a basic input output system (BIOS) of the smart network interface card;
configure parameters of the smart network interface card; and
set an initialization completion flag bit in the BMC of the smart network interface card in response to configuration of the smart network interface card is completed.
